(19) United States
(12) Patent Application Publication
(10) Pub. No.: US 2024/0247948 A1
(43) Pub. Date: Jul. 25, 2024

(54) CLOUD-BASED SYSTEM FOR CONTROLLING POSITION INDICATORS

(71) Applicant: Leading Lights, LLC, Carmel, IN (US)

(72) Inventors: Timothy Wise, Santa Cruz, CA (US); Brad Hayes, Pendleton, IN (US)

(73) Assignee: Leading Lights, LLC, Carmel, IN (US)

(21) Appl. No.: 18/544,668

(22) Filed: Dec. 19, 2023

Related U.S. Application Data
(60) Provisional application No. 63/439,977, filed on Jan. 19, 2023.

(51) Int. Cl. G01C 21/00

(52) U.S. Cl. CPC G01C 21/3896; G01C 21/387

(57) ABSTRACT

A cloud-based system for controlling a position indicator for a vehicle relative to other vehicles, such as in a race. The position indicator may be mounted to the vehicle and optionally activated by a remote cloud-based service in communication with the position indicators. Position indicators may include one or more lamps, LEDs, displays, and the like operable to present positional information. During an event (or multiple separate events) such as one or more races occurring simultaneously, the system may be configured to remotely receive timing and scoring updates for the events, determine the relative position of the participants for each event, and direct the position indicators for the different participants to display positional information so that fans at the events need not divert their attention from the event to obtain positional updates for the participants.

### CROSS-REFERENCE TO RELATED APPLICATION

This application claims the benefit of U.S. Provisional Application No. 63/439,977 filed Jan. 19, 2023, which is hereby incorporated by reference.

### BACKGROUND

Automobile, motorcycle, boating, and other types of vehicle racing are popular all around the world. Races may involve amateur drivers on small dirt ovals, or professional drivers on large tracks or open courses that are multiple miles in length. Races routinely require the participants to cover the course multiple times in a given race, and some events last hours or days requiring multiple stops for fuel and repairs.

The size of the venues and the length of the events often make it difficult for spectators to keep track of how each contestant is doing in the race. Fans routinely consult outside sources (e.g., a web page or app on a personal smart phone), or need to be in a location in the venue where a score board is visible showing the current race order. This puts limitations on where the best seats are in the venue, and often requires a viewer to divert their attention from the race. In some instances, the venue may seek to include a positional indicator on each vehicle, however, the technical complexity involved in setting up and operating such a system for each separate venue may be daunting.

### SUMMARY

Disclosed is a cloud-based system for controlling a position indicator for a vehicle. A position indicator is optionally configured to display positional information for one vehicle relative to other vehicles, such as in a race. The position indicator may be mounted to the vehicle and optionally activated by a remote cloud-based service in communication with the position indicators. The indicator may be visible to the driver, to crew members, to bystanders, to spectators, and/or other observers. During a race, the disclosed system may be configured to remotely monitor the race (or multiple races occurring at the same time), determine the relative position of the participants, and direct the position indicators for the different event participants to display positional information so that fans need not divert their attention from the race to remain informed as to who is in first, second, third, and so forth.

The positional indicators may include any suitable devices for notifying observers of a particular vehicle's position relative to other vehicles. In one example, the positional indicators include a lamp assembly with lights, LEDs, strobes, or other luminescent devices. These may be arranged separately, in elongated strings or strands of interconnected lamps, in grids or arrays, or in any other suitable configuration. The positional indicator may be mounted in any suitable location, such as on a roof, on a fin, on a wing, on the side of a vehicle, on a bib worn by a runner, and the like. It may be embedded in the structure of a vehicle or other retaining structure when the structure is manufactured, temporarily mounted to a structure by suction cups, adhesives, magnets or other fasteners, or otherwise coupled to the vehicle.

In one example, the position indicator includes a lamp, such as an LED, which may be controlled according to updates from a remote management service. For example, in a race scenario, the car in first place may have a position indicator emitting a particular color reserved for first place, the position indicator of the second place car may emit a second color reserved for second place, and so forth. This may be the case for the top three or more cars, the top five or more cars, the top 10 or more cars, or each position throughout the race may have a color or other position indicator reserved for, and displayed by, the car running in that particular position. In another aspect, the position indicator may include multiple lamps or LEDs in strings, arrays, and the like, which may be provided to increase the visibility of the indicator, such as by making it easily observable from multiple directions. In another example, the position indicator may include a display device, or multiple display devices, operable to display indicia indicating the current running position of a particular car (e.g., a “1” for first place, a “2” for second place”, a “15” for fifteenth place, and so on).

In another aspect, where the event involves a race, the disclosed system optionally receives timing and/or scoring updates as the race progresses. These updates may be provided by a timing or scoring system which may be made available by the race venue for integration with the disclosed system. The disclosed system may then optionally compute what type of position indicator should be active (if any), and what, if any, adjustments should be made as the scoring updates are received. The system may be configured to process the updates and to then optionally send commands or control signals to one or more of the indicator devices on the vehicles to change the observable position information. With this system, spectators, crew members, and any other observers may easily note the position of some, or all, of the cars, simply by watching the vehicles as they race rather than by being forced to look away from the race to consult some other source of information. Also, the venues need not duplicate the behavior of the disclosed system for each venue, rather, each venue may collaborate with the disclosed management service with minimal adjustment to the existing timing and scoring system to achieve the disclosed results.

The disclosed cloud-based system may be useful in multiple different race environments where the vehicles may vary to optionally include cars, trucks, motorcycles, boats, airplanes, bicycles, and the like. The disclosed system may optionally be used for other types of race events involving horses, dogs, and/or people, to name a few examples. For example, the position indicator system may be mounted to the human or animal participant to give a better indication of that participant's current standing in the competition. The present system may be especially helpful where multiple laps around a predetermined circuit are involved. For example, a track and field foot race event may include multiple laps run on a closed oval track. Similar to a car or motorcycle race, spectators in this venue may become easily confused as to who is leading, who is in second, and so on. In another example, the disclosed system may be useful for aiding in maintaining a particular ordering of vehicles, such as in the case of vehicles traveling in a convoy, train cars being arranged in a freight yard, or any other situation where a cloud-based system providing visual position indicators of vehicle order might be useful, and without significant overhead of duplicating the disclosed functionality on site.

Further forms, objects, features, aspects, benefits, advantages, and embodiments of the present invention will become apparent from the detailed description and drawings provided herewith.

### BRIEF DESCRIPTION OF THE DRAWINGS

FIG. 1 is a component diagram illustrating one example of components that may be included in the system of the present disclosure.

FIG. 2 is a component diagram illustrating one example of modules that may be included in a management service of the present disclosure.

FIG. 3 is a component diagram illustrating one example of components that may be included in a control circuit of the present disclosure.

FIG. 4 is a flow chart illustrating an example of actions the system of the present disclosure may take.

FIG. 5 is a flow chart illustrating another example of actions the system of the present disclosure may take.

### DETAILED DESCRIPTION

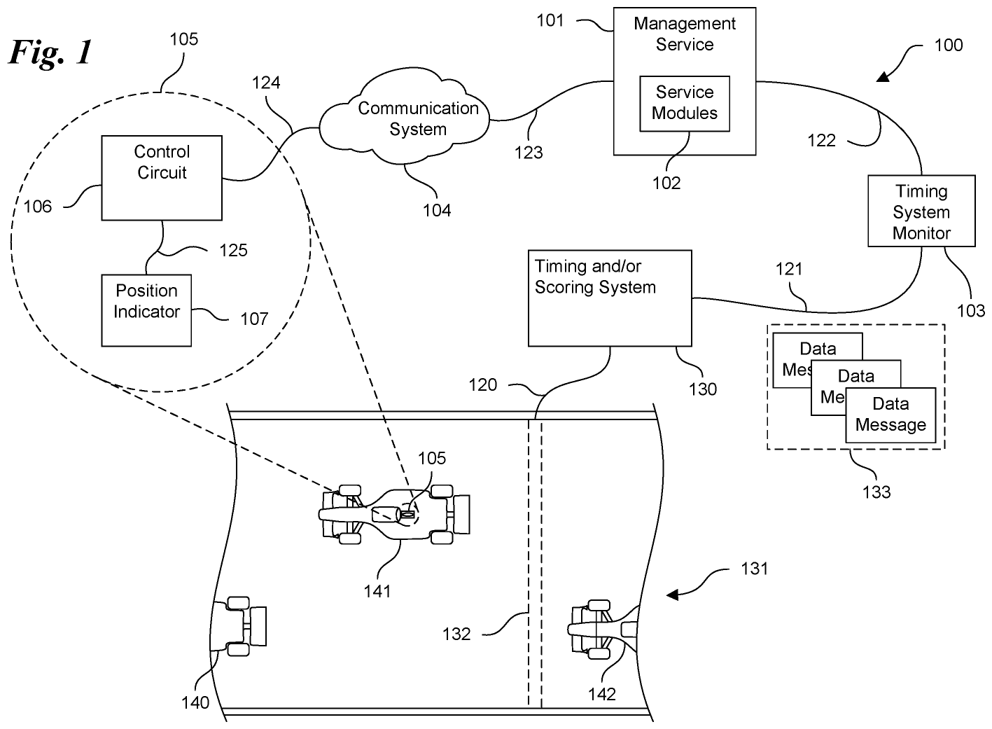

Illustrated at 100 in FIG. 1 is one example of components that may be included in a cloud-based position indication system of the present disclosure. The system optionally includes a management service 101 operable to control position indicators 107 of multiple vehicles 140-142. Many of the examples of the disclosed system are offered in the context of monitoring vehicles participating in a race. In FIG. 1, the vehicles are illustrated as race cars participating in a race at a racing venue 131. However, the system of the present disclosure may be useful for remote control of a positional indicator associated with any type of vehicle, animal, person, and the like, and therefore no limitation on its applicability solely for racing events is implied.

As illustrated in FIG. 1, the activation of position indicators 107 may be controlled by a control circuit 106 that is in communication with the management service 101 and is configured to respond to vehicle specific updates sent by the management service. The management service 101 may include one or more service modules 102 optionally comprising software, hardware, or other logical or physical components that may be configured to accept input and generate output for the purpose of controlling position indicators of the present disclosure.

In another aspect, the racing venue 131 may include a timing and/or scoring system 130 that optionally includes data capture devices 132 which may be integrated into the venue 131. For example, the data capture devices 132 may be positioned at predetermined points along the path the contestants are intended to traverse. This “path” may be a race track with a paved surface, retaining walls, grandstands, and the like, a road course laid out through a city, a dirt track carved out of a field, or an open country course that may include deserts, mountain terrain, swamp land, or other open terrain. Irrespective of the course taken, the system 130 may be informed of vehicles passing a data capture device 132 by virtue of a communication link 120 between the data capture device and the timing system. The timing/scoring system 130 may then be configured to determine the state of the race and the current running order of the contestants according to the vehicles passing these predetermined locations around the venue 131. For example, a data capture device may be positioned beneath the start-finish line of a racetrack thus providing feedback to the timing system 130 as to when a vehicle crosses the start-finish line.

Data generated by the data capture devices 132 may be received by the timing or scoring system 130 and processed to generate one or more data messages 133. In one example, a vehicle 141 may pass by the capture device 132 ahead of another vehicle 142 thus improving the position of vehicle 141 from 3^{rd} to 2^{nd} place. Timing system 130 may generate data messages 133 with a “crossing” indicator thus noting that vehicle 142 has crossed a predetermined location that includes a data capture device 132, and a timestamp indicating what time the crossing occurred. In another aspect, timing system 130 may generate a “position update” message indicating that car 141 is now in second place. Another “position update” message is optionally generated indicating that vehicle 142 is now in third place. In another aspect, the timing system 130 optionally generates messages for both race position (scored by order of crossings) and qualifying position (ordered by fastest lap time of the session).

In another aspect, the timing/scoring system 130 may be operable to broadcast the data messages 133 to any number of listening systems or devices. The data messages 133 may be delivered via any suitable communication link 121. For example, the disclosed system may include timing system monitor 103 operable to listen for and capture data messages 133, and to optionally forward those messages to the management service 101. In one aspect, the timing system monitor may include software executed on a computer that is separate and distinct from computers that may be used to implement timing system 130. In another example, the timing system 130 may be configured to include the timing system monitor 103 such as by executing software implementing the timing system monitor 103, by including hardware configured to provide the functionality of the timing system monitor, or any suitable combination thereof. Regardless of the specific architecture employed, a timing system monitor 103 is optionally present to capture data messages generated by the timing system and to forward those messages to the management service 101 via a communication link 122.

In another aspect, a separate instance of the timing system monitor 103 software and/or hardware may be provided for each different venue interested in using management service 101 to control position indicators. Separate instances of the timing system monitor 103 may thus be configured with venue specific information which may be useful to management service 101 when multiple events are occurring simultaneously at different venues. For example, management service 101 may include software and/or hardware configured to accept, sort, categorize, or otherwise manage multiple data messages 133 arriving via multiple timing system monitors 103 from multiple different venues 131. Management service 101 may thus be configured to associate incoming data messages 133 from an individual timing system monitor 103 to a given event.

The management service 101 may include any suitable computer hardware and/or software suitable for providing the disclosed functionality. For example, management service 101 may include multiple modules 102 optionally executing on one or more processors of one or more computers. The features and functionality provided by management service 101 may be implemented using any suitable programming languages, APIs, and the like, and may be executed on any suitable hardware such as a server computer, desktop computer, mainframe, or in a virtual computing environment, to name a few nonlimiting examples.

Management service 101 is optionally configured to determine from data messages 133 which position indicators to adjust and in what way. In one aspect, management service 101 is optionally configured to activate the position indicator of vehicles in the top positions for a particular race. For example, where the position indicator includes a lamp capable of emitting light in multiple different colors, the management service 101 may be configured to change the color of a lamp to one color for the top position, a second color for the next position, and so on for any suitable number of the top positions. The management service may be configured to maintain separate colors or other unique activation features for a number of positions above a predetermined threshold such as the top position, the top three positions, the top five positions, the top 10 positions, or more. In another aspect, the management service 101 may be operable to deactivate the position indicator when a vehicles position in the race has fallen below the threshold for the top positions.

In another aspect, the management service 101 is optionally operable to activate all of the position indicators with a predetermined color for vehicles in a particular event at about the same time. Examples of this might include activating all of the indicators with a yellow color in the event of a full course caution (“yellow flag”), a red color for a race stoppage (“red flag”), and the like. Other colors may be configured for different types of events effecting the entire field.

In another aspect, the management service 101 may be configured to deactivate the position indicators for all cars and/or to restore any previous positional indications once the full course event is over and the race continues. In another aspect, the management service 101 may be operable to activate a predetermined indicator for participants that qualify according to predetermined criteria. For example, the management service may activate a special unique indicator for the vehicle that has passed the largest number of other vehicles since the race began, or has passed the most other vehicles in the most recent 10 laps, most recent 50 laps, or during some other predefined period of time.

In another aspect, management service 101 is optionally configured to parse the incoming data messages and compute the standings for events that are in progress. This process may occur in real time so that position indicators for the vehicles involved may be updated accordingly as the event progresses. In another aspect, management service 101 may be configured to maintain a mapping of vehicles identified in the data messages 133 to specific vehicles in the venue. For example, management service 101 may maintain in a memory a mapping of transponder IDs associated with individual vehicles 140-142 to separate and distinct control circuits 106. This mapping may be updated prior to the start of the event, and is optionally maintained individually for each event for each venue to enable the management service 101 to control position indicators for multiple vehicles at multiple venues at about the same time.

The position indicator 107 and the control circuit 106 may together comprise a position indicator assembly 105. A position indicator assembly may be coupled to the vehicle prior to the event, manufactured as part of the structure of the vehicle, or otherwise associated with each separate vehicle. For example, control circuit 106 and the position indicator 107 may both be mounted together in a common housing attachable to a vehicle. The communication link 125 may be implemented by electrically connecting the control circuit 106 to the position indicator 107. In another aspect, the control circuit 106 may be mounted to the vehicle in one location, while the position indicator 107 may be mounted on the vehicle in a second location that is separate and distinct from the first location. The control circuit and the position indicator may communicate via a wired, wireless, or other communication link.

The control circuit 106 may optionally be responsive to management service 101 by means of a communication system 104. This communication system may use any suitable type of communication links 124 and 123. For example, the communication may include a publicly accessible computer network such as the internet, a Virtual Private Network (VPN), and/or one or more wireless communication services using cellular telephone communication services, Long Range Wide Area Network (LoRaWAN), and the like. The communication system 104 may include other services, servers, computers, and the like, which may interact with suitable wireless communication services operable to communicate wirelessly with the control circuit. In one example, communication system 104 may use an Internet of Things (IoT) or other cloud-based platform or API for sending indicator specific instructions for individual vehicles. Any suitable communication services may be employed in the system of the present disclosure to send vehicle specific control signals to individual position indicators 107.

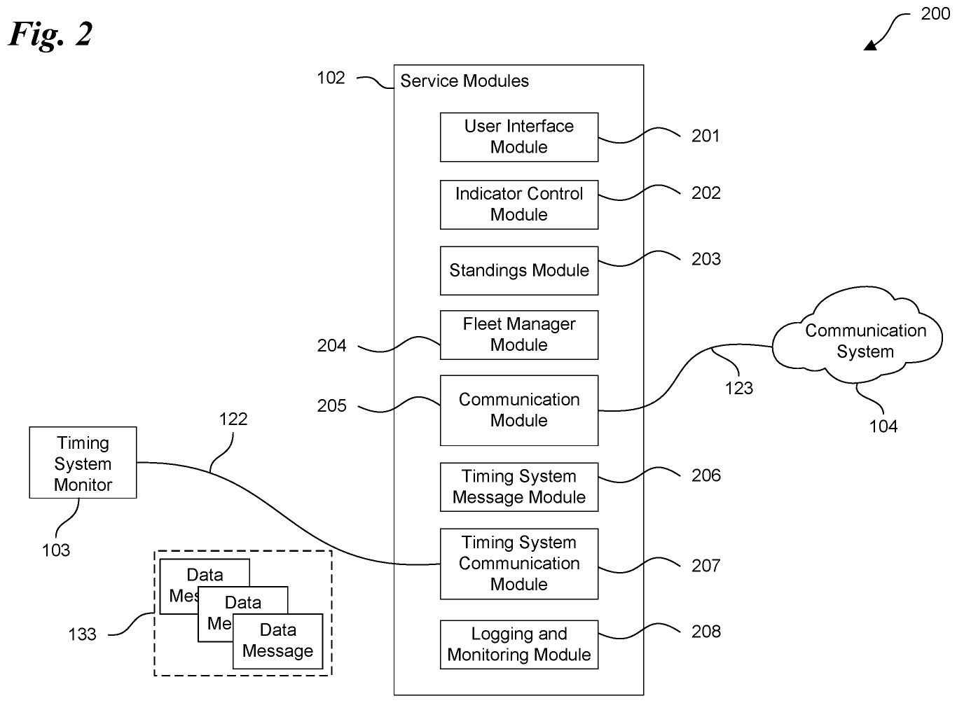

FIG. 2 illustrates one example of service modules 102 that may be included in the management service 101. These modules may be implemented in software, hardware, or any suitable combination of the two. The disclosed modules may be configured to execute on one or more processors of one or more computers tasked with providing the features and functionality of the management service 101.

In one aspect, service modules 102 may include a user interface module 201. The user interface module 201 may be configured to provide a user interface operable to accept input from a user defining aspects of the vehicles participating in an event at a particular venue, establishing communication links between the timing system and the control circuits, and/or for specifying event or venue specific configuration parameters. In another aspect, the user interface module 201 may be configured to provide operational status updates for the management service, one or more vehicle control circuits or position indicators for specific vehicles, event or venue related updates, or other aspects of the disclosed system to confirm that it is functioning as expected.

In another aspect, a timing system communication module 207 may be included for managing and maintaining aspects of communication link 122 between the management service 101 and the timing system monitor 103. For example, the timing system communication module 207 may provide access to the management service via a port, socket, or other such network connection that may be made available to timing system monitors 103 of multiple venues. The timing system monitor 103 may be configured to initiate a network connection with the management service 101 that is maintained by the timing system communication module 207. The timing system communication module 207 may also include or use authentication services or APIs in order to authenticate access and to deny access to the management service 101 when authentication fails. Any suitable connectivity technology or protocols may be implemented by the timing system communication module 207 such as, for example standard sockets, WebSockets, or WebTransport to name a few nonlimiting examples. In this configuration, changing the protocol or communication service used to communicate between the timing system monitor 103 and the management service 101 may only require changes to the timing system communication module 207 without modifying other aspects of the service modules 102.

In another aspect, a timing system message module 206 may be included and may be configured to parse data messages 133 passed to the management service 101 from the timing system monitor 103. In this respect, the timing system message module 206 optionally obtains the messages from the timing system communication module 207 which may be configured to maintain the communication link with the timing system monitor 103. The timing system message module 206 optionally parses or otherwise processes data messages 133 before making them available to the standings module 203.

The standings module 203 may be configured to determine changes to the state of a race based on the data messages 133. Standings module 203 may maintain the standings and position of each vehicle for each separate event in real time. The standings information maintained by the standings module 203 maybe maintained in a memory of the monitoring service, and/or optionally logged by the logging and monitoring module 208 for monitoring and debugging purposes.

An indicator control module 202 may optionally obtain standings information from the standings module 203 and may be configured to determine which indicators to activate for a given vehicle. For example, the indicator control module 202 may maintain a predetermined threshold of top placed vehicles such as the top three vehicles, the top five vehicles, and so forth. The indicator control module 202 may adjust this threshold throughout the event according to manual input received from the user interface module 201, according to predetermined criteria maintained by the indicator control module 202, and the like. Upon determining that a particular vehicle in a particular event should display a particular type of indicator based on its position, the indicator control module 202 may be configured to automatically generate a command that may be passed to a fleet manager module 204.

The fleet manager module 204 may accept commands from the indicator control module 202 to adjust indicators for particular vehicles. It may also log those commands by passing the commands to the logging and monitoring module 208. The fleet manager module 204 may forward commands for specific indicator activation and deactivation for particular vehicles to the communication module 205.

The vehicle communication module 205 may be configured to maintain the communication link 123 with the communication system 104. For example, the vehicle communication module 205 may interact with any suitable service by which delivery of the specific commands may be made. For example, the communication module 205 may communicate with individual vehicles using an IoT or other cloud-based communication API. With this configuration illustrated in FIG. 2, changing the management service to use a different communication protocol, or service, to communicate with the individual vehicles may only require modifying the vehicle communication module 205 to accept the new protocol or service without modifying other aspects of the service modules 102.

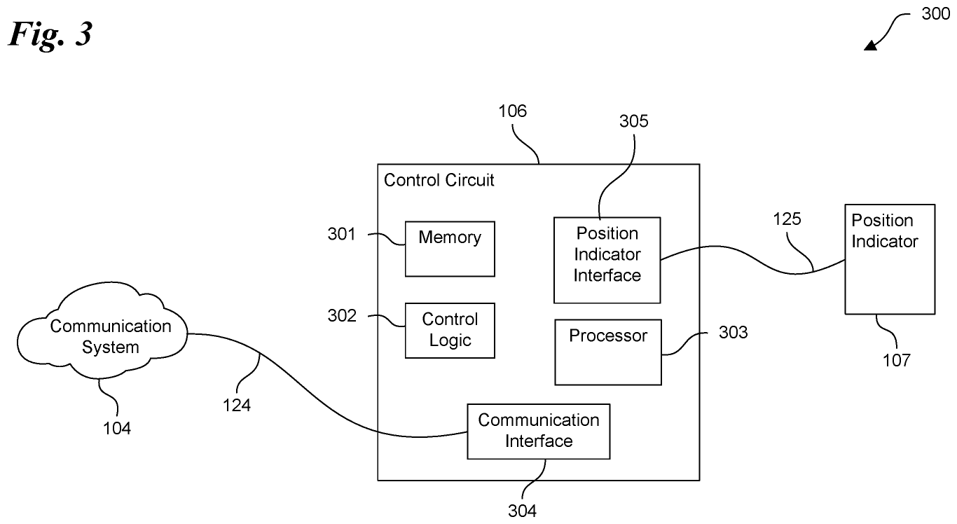

Illustrated in FIG. 3 is one example of components that may be included in a control circuit of the present disclosure. As discussed herein elsewhere, the control circuit 106 is optionally provided to bridge the communication gap between the management service 101 and a position indicator 107 mounted to a particular vehicle. The control circuit may include a memory 301 for storing the state of position indicator 107, configuration parameters defining when and how position indicator 107 may be activated or deactivated, or other operational parameters. For example, memory 301 may include information specifying which vehicle the control circuit 106 is currently mounted to or otherwise associated with. In another example, memory 301 may include state information that is updated during an event such as the current race position for the vehicle, whether the race is under caution, and the like. Memory 301 may include volatile, and/or nonvolatile portions, and either or both of these may be updated remotely via the management service and communication system 104.

Control logic 302 may be included in the control circuit 106. The control logic 302 may be implemented in any suitable hardware or software configuration. For example, the control logic may be implemented as a program using any suitable programming language (or languages), software libraries, or Application Programming Interfaces (APIs). The control logic 302 implemented in software may be executed by a processor 303 which may include any suitable arrangement of microcontrollers, microprocessors, logic circuits, and the like. In another aspect, control logic 302 may include hardware such as a Field Programmable Gate Array (FPGA), a Programmable Logic Circuit (PLC), Application-Specific Integrated Circuits (ASICs), a custom arrangement of general-purpose logic gates, and the like. In another aspect, control logic 302 may be implemented as software and may be stored in memory 301, or stored in a separate memory.

In another aspect, a communication interface 304 may be provided and may be configured to provide and maintain the communication link 124 with the communication system 104. The communication interface 304 may thus be operable to accept input from the management service 101, and optionally to provide feedback to the management service 101 regarding operation of the control circuit 106.

A position indicator interface 305 is optionally included in the control circuit for the purpose of activating and deactivating the position indicator 107. The position indicator interface 305 may be electrically connected to the position indicator 107, or may otherwise communicate with the position indicator via communication link 125. For example, the position indicator 107 may include one or more lamps in a string, array, or in any other suitable configuration. These lamps may include, or be implemented as, one or more LEDs. The position indicator interface 305 may be configured with switching devices for modifying the electrical power to portions of the position indicator so as to selectively activate and/or deactivate different circuits of the position indicator. In another aspect, the position indicator interface 305 may include switching devices for modifying an electrical connection between circuits of the position indicator and a circuit ground so as to selectively activate and/or deactivate circuits of the position indicator accordingly. The position indicator interface 305 may thus control power to the position indicator 107 based on signals, commands, or other input from processor 303, and/or control logic 302.

In another aspect, the position indicator 107 may include lamps, or other indicators, operable to emit multiple colors, and these colors may be controlled by the position indicator interface according to input received from the control logic 302, and/or the processor 303.

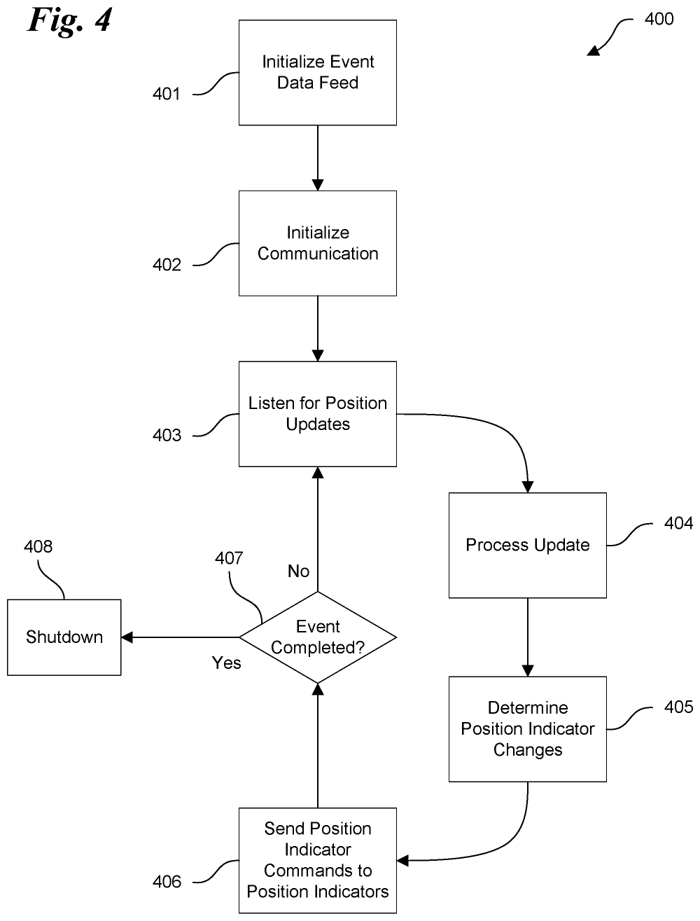

Illustrated in FIG. 4 at 400 is one example of actions the disclosed system may take to provide the disclosed cloud-based remote control of position indicators. At 401, the system optionally initializes the event data feed for a given event, or for multiple events occurring at the same time. Initializing the event data feed may include, but may not be limited to, creating and initializing one or more communication links between different parts of the system. For example, timing system monitor 103 may connect to the timing/scoring system 130 thus creating communication link 121 according to any suitable protocol. The timing system monitor 103 may also notify the system 130 that it is ready to consume time and/or scoring data messages 133, or other information the timing system 130 may provide.

In another aspect, initializing an event data feed at 401 may include establishing the communication link 122 between the management service 101 and timing system monitor 103. This link may be established by either the timing system monitor or the management service, or both, and may be created and maintained using any suitable electronic communication protocol. For example, timing system monitor 103 may open a socket connection to a port maintained by the management service 101, and may notify the management service 101 that an event is starting.

Initializing the event data feed may also include establishing communication links 123 and 124 between the management service 101 and the communication service or system 104. As discussed herein elsewhere, management service 101 may use other communication services or protocols, and initializing the event data feed may include activating those systems or services so that the management service 101 is ready to communicate with all of the vehicle control circuits 106.

Initializing the event data feed may also include activating the position indicator assembly 105 for each of the vehicles involved in the event. For example, this may involve manually, or remotely powering up the position indicator assembly 105 for each vehicle. The vehicle control circuit 106 may thus communicate with the communication system 104 to establish the communication link 124 thereby readying the control circuits and position indicators for each vehicle to receive commands from the management service 101.

In another aspect, initializing vehicle communication at 402 may include providing configuration parameters to the management service and/or to each separate vehicle. These parameters may include, but are not limited to, information associating vehicle identification information used by the timing system 130 to uniquely identify each vehicle in each event with information uniquely identifying each position indicator assembly 105. This may include, processing information provided by the timing system 130 identifying the relationship between a timing system transponder of each vehicle, and a position indicator assembly 105. In this way, the management service 101 may be configured to associate data provided by the timing system 130 with one or more position indicators 107 of one or more vehicles.

At 403, the disclosed system optionally begins listening for positional updates such as may occur once an event starts. As updates are received, such as in the form of data messages 133, the updates may be processed at 404 according to the present disclosure. If a positional indicator, or multiple indicators, needs to be adjusted, this determination may be made at 405, and a position indicator adjustment may be sent to of the position indicator(s) at 406. If the event is not completed yet, as determined by the timing system, the system optionally continues to listen for more position updates. Actions 403-407 may thus continue until an event is completed at 407, in which case processing is completed at 408.

When an event is completed, the system may optionally go through a shutdown procedure at 408. This procedure may include notifying the control circuits of every vehicle for a given event to power down the position indicator, and/or to terminate the communication links with the communication system 104, the timing system monitor 103, and the timing system 130.

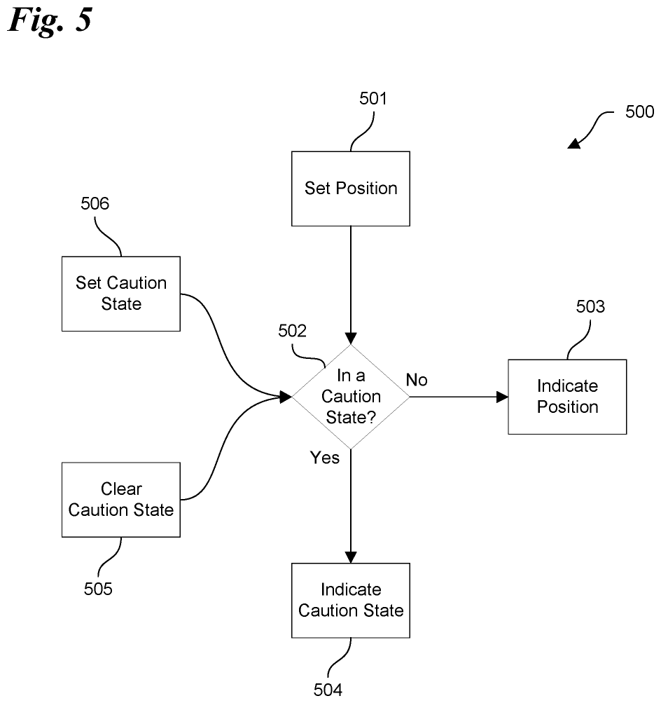

Illustrated in FIG. 5 is an example of actions the control logic of a control circuit 106 may be configured to take. In this example, the disclosed arrangement of actions may be useful for reducing the number of messages or commands the management service is required to send in order to handle caution states for a given event.

For example, at 501, the management service may send an update to the control circuit setting the position. This optionally indicates to the control circuit what position the associated vehicle is currently running in. If the event is currently not under a caution flag at 502, then the control logic will optionally indicate the position at 503. Indicating the position, as disclosed herein elsewhere, may include turning on an LED, string of LEDs, or changing the color of one or more LEDs, and so forth, depending on the criteria used by the control circuit. In some instances, the control logic may be configured by the management service to only activate the position indicator at 503 when the vehicle is in the top three positions, in the top 10 positions, or has passed more vehicles than any other vehicle so far, and the like. The indicated position may be continuously displayed at 503 until an event occurs that might cause it to change. For example, the management service may send a new “set position” command to the control circuit at 501 thus indicating a change in position. When the event is not under caution at 502, the newly indicated position may be displayed at 503.

In another aspect, the indicated position at 503 may be changed when the management service optionally signals to the control circuit that the event is under caution at 506. The control logic may be configured to save the current position in memory, and to set a caution state. Thus at 502, the control logic will indicate a caution state of 504 rather than indicating the position 503. Indicating a caution state may include activating the position indicator with one or more orange lamps that may be steady on, flashing, and the like. In another aspect, all of the vehicles in a given event may include this logic thus making it possible to activate a caution state for all vehicles at the same time with a single message broadcast to all vehicles.

The management service may continue to send positional updates to individual vehicles at 501 in the event that vehicles change position under caution. This may occur, for example, as vehicles exit the racetrack for pitstops, and then reenter the racetrack in a different position. In this case, the control logic may continue to store the updated position indication in memory, but given that the control logic is in a caution state, the indicated position is optionally not displayed at 503 in favor of continuing to display the caution state at 504.

The caution state may remain in effect thus causing the caution state indicator to be emitted by the position indicator at 504. This may continue indefinitely until either the event is over, or a clear caution state message is received at 505. When a venue indicates that the event is no longer under caution, the management service may optionally send another single message to all vehicles for a given event indicating that the caution state is no longer in effect at 505. At 502, the control logic may then revert to indicating the present position according to the rules in the control logic. The control logic may then continue to display the indicated position 503 as position updates are received at 501.

### System Clauses

The following numbered clauses set out examples of the disclosed system that may be useful in understanding the present disclosure:

Example 1: A cloud-based system for controlling a position indicator for a vehicle.

Example 2: The system of any other example, including a position indicator assembly that includes a position indicator for a vehicle that is configured to display the position of the vehicle relative to other vehicles.

Example 3: The system of any other example, including a management service remote from the position indicator assembly, wherein the position indicator assembly is responsive to input from the management service via a communication link, and wherein the management service is operable to change the position displayed by the position indicator.

Example 4: The system of any other example, wherein the position indicator assembly comprises a control circuit operable to communicate with the management service.

Example 5: The system of any other example, wherein the control circuit is responsive to a management service.

Example 6: The system of any other example, wherein the position indicator is responsive to control input from a control circuit indicating the position displayed by the position indicator.

Example 7: The system of any other example, wherein the position indicator includes one or more lamps.

Example 8: The system of any other example, wherein the position indicator includes one or more LEDs.

Example 9: The system of any other example, wherein the position indicator is operable to generate a position indicator that is defined by light emitted with a predetermined color.

Example 10: The system of any other example, wherein the position indicator is operable to change the color of light emitted by the indicator.

Example 11: The system of any other example, wherein the position indicator is defined by a recognizable pattern of light defining the position relative to other vehicles.

Example 12: The system of any other example, wherein position indicator assembly is arranged and configured to activate and deactivate aspects of the position indicator in response to commands received from the management service.

Example 13: The system of any other example, wherein the position indicator includes multiple different colored lamps.

Example 14: The system of any other example, wherein the position indicator assembly is configured to activate different lamps of the lamp assembly to indicate positional information about the individual vehicles

Example 15: The system of any other example, wherein the management service is operable to receive timing and/or scoring data about multiple vehicles having position indicators from a timing system.

Example 16: The system of any other example, wherein the management service is configured to determine the relative position of multiple different vehicles.

Example 17: The system of any other example, wherein the management service is configured to determine the relative position of vehicles according to timing data received from the timing/scoring system.

Example 18: The system of any other example, wherein the management service is configured to send different position commands to the position indicator assemblies of multiple vehicles based on the relative position of the vehicles with respect to each other.

Example 19: The system of any other example, wherein the management service is configured to send a single indicator update command to the position indicator assemblies of multiple vehicles.

Example 20: The system of any other example, wherein the position indicators of the multiple vehicles are operable to display the same position indicator according to the single indicator update command.

Example 21: The system of any other example, wherein the timing/scoring system is configured to determine the location of multiple different vehicles according to input received from sensors at one or more predetermined locations.

Example 22: The system of any other example, wherein the system is configured to identify the individual vehicles as they pass predetermined locations that include sensors.

Example 23: The system of any other example, wherein the vehicles are participating in an event at a venue.

Example 24: The system of any other example, wherein the management services is executed as a running process executed by one or more processors of one or more computers.

Example 25: The system of any other example, wherein at least one of the computers executing the management services is remote from a venue where an event is taking place.

### Method Clauses

The following numbered clauses set out examples of the disclosed method that may be useful in understanding the present disclosure:

Example 1: A method of controlling a position indicator for a vehicle using a cloud-based management service.

Example 2: The method of any other example, including accepting position updates using a management service.

Example 3: The method of any other example, wherein the position updates include information about the relative position of a vehicle relative to other vehicles.

Example 4: The method of any other example, wherein the management service is executed using one or more processors of one or more computers.

Example 5: The method of any other example, including determining if a vehicle has changed position relative to another vehicle using the management service.

Example 6: The method of any other example, including sending a position indicator command to a vehicle using the management service when a vehicle changes position relative to another vehicle.

Example 7: The method of any other example, including initializing communication between the management service and the vehicle.

Example 8: The method of any other example, including initializing communication between the management service and a position indicator assembly of the vehicle.

Example 9: The method of any other example, including initializing communication between the management service and a timing and/or scoring system of a venue, wherein the vehicles are participating in an event at the venue.

Example 10: The method of any other example, including processing position updates using the management service, wherein the position updates are received from a timing/scoring system of a venue.

Example 11: The method of any other example, including comparing position updates with predetermined positional criteria using the management service in order to determine a position indicator change to send to at least one vehicle.

Example 12: The method of any other example, including determining portions of the position indicator to activate and/or deactivate based on a command received from the management service using control logic of the position indicator assembly.

Example 13: The method of any other example, wherein the position indicator includes one or more lamps.

Example 14: The method of any other example, wherein the position indicator includes one or more LEDs.

Example 15: The method of any other example, wherein the position indicator assembly includes a control circuit operable to activate and deactivate different LEDs of the one or more LEDs according to input received from the management service.

Example 16: The method of any other example, including initializing wireless communication links between multiple position indicator assemblies of multiple vehicles operating in a venue and a management service, wherein a timing/scoring system of the venue is operable to determine relative positions of the multiple vehicles, wherein the management service is responsive to timing input from the timing/scoring system via a computer network, wherein the management service is remote from the multiple position indicator assemblies of the vehicles, and wherein the management service is executed using one or more processors of one or more computers.

Example 17: The method of any other example, including accepting timing data from the timing/scoring system using the management service, wherein the timing data includes information about changes to the relative position of the multiple vehicles relative to each other;

Example 18: The method of any other example, including using the management service to process the timing data to determine vehicle position changes that occur when the position of one vehicle changes relative to another vehicle within the venue;

Example 19: The method of any other example, including comparing vehicle position changes with indicator criteria using the management service to determine an updated position to one or more vehicles of the multiple vehicles operating in the venue;

Example 20: The method of any other example, including sending the updated position to the at least one of the multiple vehicles using the management service and the wireless communication links between the management service and the one or more vehicles; and

Example 21: The method of any other example, including adjusting the position indicator assembly for the one or more vehicles to display the updated position.

Example 22: The method of any other example, including initializing additional wireless communication links between multiple other position indicator assemblies of multiple other individual vehicles and the management service, wherein the multiple other vehicles are operating in a second different venue, wherein a second timing/scoring system of the second venue is operable to determine relative positions of the other multiple vehicles, wherein the management service is responsive to timing input from the second timing/scoring system via the computer network, wherein the management service is remote from the other multiple position indicator.

Example 23: The method of any other example, wherein the position indicator includes one or more LEDs operable to activate or deactivate according to the position indication received from the management service.

Example 24: The method of any other example, wherein the multiple position indicator assemblies include: a position indicator that is arranged and configured to display the position of the vehicle relative to other vehicles.

Example 25: The method of any other example, wherein the multiple position indicator assemblies include: a control circuit, wherein the position indicator is responsive to control input from the control circuit defining the position displayed by the position indicator, and wherein the control circuit is responsive to the management service via at least one of the wireless communication links.

Example 26: The method of any other example, including accepting a caution indication from the timing service using the management service.

Example 27: The method of any other example, including sending a caution message from the management service to the multiple position indicator assemblies, wherein control logic of the multiple position indicator assemblies is operable to receive the caution message and to activate a caution mode of the control logic.

Example 28: The method of any other example, including triggering a caution indicator of the position indicator assembly when the caution mode is activated.

Example 29: The method of any other example, wherein the caution indicator is displayed instead of the position when the caution mode is activated.

Example 30: The method of any other example, including accepting a clear caution indication from the timing service using the management service.

Example 31: The method of any other example, including sending a clear caution message from the management service to the multiple position indicator assemblies, wherein the control logic is operable to deactivate the caution mode when the clear caution message is received.

Example 32: The method of any other example, wherein the position indicator is displayed instead of the caution indicator when the caution mode is deactivated.

Example 33: The method of any other example, wherein the updated position is sent to all of the multiple vehicles, and wherein control logic of the multiple position indicator assemblies is configured to match the update sent to the at least one of the multiple vehicles position update is meant for.

Example 34: The method of any other example, wherein the position indicator includes one or more LEDs.

Example 35: The method of any other example, wherein the position indicator is operable to emit light of differing colors corresponding to the position.

Example 36: The method of any other example, wherein the position indicator defines a recognizable pattern corresponding to the position received from the management service.

Example 37: The method of any other example, wherein the position indicator defines a numerical pattern corresponding to a numerical position received from the management service.

Example 38: The method of any other example, wherein the wherein the management service is executed as a running process executed by the one or more processors of the one or more computers, and wherein at least one of the one or more processors is remote from the venue.

Example 39: The method of any other example, wherein the wherein the management service is executed as a running process executed by the one or more processors of the one or more computers, and wherein at least one of the one or more processors is located in the venue.

Example 40: The method of any other example, wherein the multiple vehicles include multiple cars.

Example 41: The method of any other example, wherein the multiple position indicator assemblies include multiple position indicators mounted in different locations on the multiple vehicles.

Example 42: The method of any other example, wherein the venue is a racing venue having a predefined racecourse, and the multiple vehicles are any one of cars, motorcycles, trucks, aircraft, or watercraft.

Example 43: The method of any other example, wherein the position indicator assembly includes a control circuit operable to activate and deactivate the one or more lamps according to input received from the management service.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

Unless otherwise stated, actions or steps performed in a method are presumed to be optional and/or executable in any order, not necessarily only in the order described, unless specifically indicated otherwise. Method steps may be presented in a particular order in the accompanying drawings and detailed description, however, this is illustrative rather than restrictive, unless otherwise indicated. Method steps may be performed asynchronously, in parallel, synchronously, or in any suitable combination thereof.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster's and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“And/or” is inclusive here, meaning “and” as well as “or”. For example, “P and/or Q” encompasses, P, Q, and P with Q; and, such “P and/or Q” may include other elements as well.

“Communication Link” generally refers to a connection between two or more communicating entities and may or may not include a communications channel between the communicating entities. The communication between the communicating entities may occur by any suitable means. For example, the connection may be implemented as an actual physical link, an electrical link, an electromagnetic link, a logical link, or any other suitable linkage facilitating communication. A communication link may include any suitable combination of hardware and software. Such hardware may include antennas, transmitters, receivers, transducers, emitters, routers, sensors, switches, networking endpoints, repeaters, hubs, and the like.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

In the case of a logical link, the communication link may be a conceptual linkage between a sender and a recipient, a producer and a consumer, or a relationship defined by logical rules, such as in the case of a series of logic gates where an output is communicated automatically as defined by the arrangement of gates in the logical link starting at one or more inputs. A logical link may be implemented using any combination of physical, electrical, electromagnetic, or other types of communication links.

“Communication System” generally refers to an arrangement of cooperating devices or systems configured to communicate with each other. The communication system may use electric or non-electric sources such as graphic images, electromagnetic radiation, the human voice, digital or analog data, and the like, and may carry information provided by these sources as electric or nonelectric signals.

A communication system may include input transducers or sensors to capture input from the sources. Such sensors may include microphones, cameras, keyboards, motion sensors, light sensors, or other such transducers for capturing some aspect from one location or environment and converting or capturing it as input. A transmitter may be included to convert captured information from the input sources into electric signals and may include aspects such as noise filters, analog-to-digital converters, encoders, modulators, signal amplifiers, and the like to prepare the captured input for transmission. Transmission may be achieved by an antenna, or any suitable device for converting the input to electromagnetic energy in any suitable form.

A receiver may be included to accept signals from a transmitter via a receiving antenna, the receiver may be configured to capture and reconstruct the signal as it was before transmission. The receiver may include components such as noise filters, digital to analog converters, decoders, demodulators, signal amplifiers, and the like. An output transducer may be included that is coupled to the receiver in any suitable way and is configured to convert the signals from a receiver to a different form such as the original form the information was in before it was transmitted. Such output transducers may include speakers for audio output, monitors displaying visual output, motors or actuators for translating the transmitted signal into movement or motion, lights, or other devices responsive to a signal output by the receiver.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus, a computer may include one or more physical processors or other computing devices or circuitry and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Computer Software”, or “Software” generally refers to input to a computer that defines instructions and/or data specifying how the computer is to perform a series of actions. This is in contrast to physical hardware which is configured to actually perform the steps specified in the software. Examples include computer programs, libraries and related non-executable data, such as online documentation or digital media. Software includes processor specific instructions usually expressed as bits of binary data values signifying processor instructions that change the state of the computer from its preceding state. For example, an instruction may change the value stored in a particular storage location in the computer—an effect that is not directly observable to the user. An instruction may also invoke one of many input or output operations, for example displaying some text on a computer screen; causing state changes which should be visible to the user. The processor optionally executes the instructions in the order they are provided, unless it is instructed to “jump” to a different instruction, or is interrupted by the operating system.

Software may be written in high-level programming languages. These may be easier and more efficient for programmers to use because they are closer to natural languages than machine languages. High-level languages are translated into machine language using a compiler or an interpreter or any combination thereof. Software may also be written in a low-level assembly language, which has strong correspondence to the computer's machine language instructions and is translated into machine language using an assembler.

“Control circuit” or “Control Logic” or “Controller” generally refer to a device configured to alter the operating conditions of another device or system using any suitable means such as mechanical, hydraulic, pneumatic, electronic, or other aspects. These may include, but are not limited to, a microprocessor or computer, to monitor and physically alter the operating conditions of a given device or system.

In one aspect, a control circuit is optionally configured to provide signals or other electrical impulses that may be received and interpreted by the controlled device to indicate how it should behave. In another aspect, a control circuit may also be configured to accept input from and provide output to a wide array of input and output devices. Such devices include other computers, keyboards, mice, visual displays, printers, industrial equipment, and systems or machinery of all types and sizes.

A control circuit may be a single, physical, computing device such as a desktop computer or a laptop computer, or may be composed of multiple devices of the same type such as a group of servers operating as one device in a networked cluster, or a heterogeneous combination of different computing devices operating as one control circuit and linked together by a communication network. The communication network connected to the control circuit may also be connected to a wider network such as the Internet. Thus, a control circuit may include one or more physical processors or other computing devices or circuitry and may also include any suitable type of memory.

A control circuit may also be a virtual computing platform having an unknown or fluctuating number of physical processors and memories or memory devices. A control circuit may thus be physically located in one geographical location or physically spread across several widely scattered locations with multiple processors linked together by a communication network to operate as a single control circuit. Multiple control circuits or computing devices may be configured to communicate with one another or with other devices over wired or wireless communication links to form a network. Network communications may pass through various control circuits operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

In one non-limiting example, the control circuit can include a Programmable Logic Control circuit (PLC), and Application Specific Integrated Circuit (ASIC), a Field Programmable Gate Array (FPGA), or other circuits incorporating these and other electronic components in any suitable arrangement such as diodes, transistors, logic gates, and the like. A control circuit may include a processor for performing calculations to process input or output. A control circuit may include a memory for storing values to be processed by the processor or for storing the results of previous processing.

For example, a control circuit may be operable to control a computer network or network interface to perform various network communications upon request. The network interface may be part of the control circuit, or characterized as separate and remote from the control circuit.

In another example, a control circuit may be configured to control a vehicle drivetrain for the purpose of directing the vehicles movements. The control circuit may be incorporated in the vehicle, or separate from it.

“Current” generally refers to the rate of flow of electric charge past a point or region. An electric current is said to exist when there is a net flow of electric charge through a region. When an electric current flows in a suitably shaped conductor at radio frequencies, radio waves can be generated. These travel at about the speed of light and can cause electric currents in distant conductors. Electric currents cause Joule heating, and may be useful for creating magnetic fields.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data).

In another aspect, the DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (xML) to allow a single application to work with more than one DBMS.

In another aspect, a database may implement “smart contracts” which include rules written in computer code that automatically execute specific actions when predetermined conditions have been met and verified. Examples of such actions include, but are not limited to, releasing funds to the appropriate parties, registering a vehicle, sending notifications, issuing a certificate of ownership transfer, and the like. The database may then be updated when the transactions specified in the rules encoded in the smart contract are completely executed. In another aspect, the transaction specified in the rolls may be irreversible and automatically executed without the possibility of manual intervention. In another aspect, only parties specified in the rules of the smart contract who have been granted permission may be notified or allowed to see the results.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, chained model (such as in the case of a “blockchain” database), the “object-relational” model, the “file”, “indexed file” or “flat-file” models, the “hierarchical” model, the “network” model, the “document” model, the “xML” model using some variation of xML, the “entity-attribute-value” model, and others.

Examples of commercially available database management systems include PostgreSQL provided by the PostgreSQL Global Development Group; Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, California, USA; the DBMS generally referred to as “SAP” provided by SAP SE of Walldorf, Germany; and the DB2 DBMS provided by the International Business Machines Corporation (IBM) of Armonk, New York, USA.

The database and the DBMS software may also be referred to collectively as a “database”. Similarly, the term “database” may also collectively refer to the database, the corresponding DBMS software, and a physical computer or collection of computers. Thus, the term “database” may refer to the data, software for managing the data, and/or a physical computer that includes some or all of the data and/or the software for managing the data.

“Display device” generally refers to any device capable of being controlled by an electronic circuit or processor to display information in a visual or tactile. A display device may be configured as an input device taking input from a user or other system (e.g., a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, yellow, and green indicators configured to indicate a temperature range.

“Electric Circuit” generally refers to the path followed by electrons from a generation source, through an electrical system, and returning to the source. An electric circuit may be open or closed. When an electric circuit is open, there is a break in the continuity of the circuit. As a result, the electrons are unable to flow. For example, when the wires of a circuit are disconnected the circuit is said to be open. When an electric circuit is closed, there is no break in the continuity of the circuit. As a result, the electrons are able to flow. For example, when the wires of a circuit are properly connected, with no breaks, the circuit is said to be closed.

“Electrically Connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Electromagnetic Energy” generally refers to a form of energy that can be reflected or emitted from objects through electrical or magnetic waves traveling through matter, through space, or any combination thereof. Electromagnetic energy comes in many examples including, but not limited to, gamma rays, x-rays, ultraviolet radiation, visible light, microwaves, radio waves and infrared radiation.

“Ground” or “circuit ground” generally refers to a node in an electrical circuit that is designated as a reference node for other nodes in a circuit. It is a reference point in an electrical circuit from which voltages are measured, a common return path for electric current, and/or a direct physical connection to the Earth.

“Input Device” generally refers to any device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Lamp” generally refers to an electrical device configured to produce light using electrical power. The generated light may be in the visible range, ultraviolet, infrared, or other light. Example illumination technologies that may be employed in a lamp include, but are not limited to, incandescent, halogen, LED, fluorescent, carbon arc, xenon arc, metal-halide, mercury-vapor, sulfur, neon, sodium-vapor, or others.

“Light Emitting Diode” or “LED” generally refers to a diode that is configured to emit light when electrical power passes through it. The term may be used to refer to single diodes as well as arrays of LED's and/or grouped light emitting diodes. This can include the die and/or the LED film or other laminate, LED packages, said packages may include encapsulating material around a die, and the material, typically transparent, may or may not have color tinting and/or may or may not have a colored sub-cover. An LED can be a variety of colors, shapes, sizes and designs, including with or without heat sinking, lenses, or reflectors, built into the package.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (xDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Microcontroller” or “MCU” generally refers to a small computer on a single integrated circuit. It may be similar to, but less sophisticated than, a System on a Chip or “SoC”; an SoC may include a microcontroller as one of its components. A microcontroller may contain one or more CPUs (processor cores) along with memory and programmable input/output peripherals. Program memory in the form of ferroelectric RAM, NOR flash or OTP ROM may also be included on the chip, as well as a small amount of RAM. Microcontrollers may be designed for embedded applications, in contrast to the microprocessors used in personal computers or other general purpose applications consisting of various discrete chips.

Microcontrollers may be included in automatically controlled products and devices, such as automobile engine control systems, implantable medical devices, remote controls, office machines, appliances, power tools, toys and other embedded systems. An MCU may be configured to handle mixed signals thus integrating analog components needed to control non-digital electronic systems.

Some microcontrollers may use four-bit words and operate at frequencies as low as 4 kHz, for low power consumption (single-digit milliwatts or microwatts). They will generally have the ability to retain functionality while waiting for an event such as a button press or other interrupt; power consumption while sleeping (CPU clock and most peripherals off) may be just nanowatts, making many of them well suited for long lasting battery applications. Other microcontrollers may serve performance roles, where they may need to act more like a Digital Signal Processor (DSP), with higher clock speeds and power consumption. A micro-controller may include any suitable combination of circuits such as:
1. a central processing unit—ranging from small and simple processors with registers as small as 4 bits or list, to complex processors with registers that are 32, 64, or more bits
2. volatile memory (RAM) for data storage
3. ROM, EPROM, EEPROM or Flash memory for program and operating parameter storage
4. discrete input and output bits, allowing control or detection of the logic sate of an individual package pin
5. serial input/output such as serial ports (UARTs)
6. other serial communications interfaces like FC, Serial Peripheral Interface and Controller Area Network for system interconnect
7. peripherals such as timers, event counters, PWM generators, and watchdog
8. clock generator—often an oscillator for a quartz timing crystal, resonator or RC circuit
9. many include analog-to-digital converters, some include digital-to-analog converters
10. in-circuit programming and in-circuit debugging support

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAx), infrared channel or satellite band, or any wireless local area network (Wi-Fi) such as those implemented using the Institute of Electrical and Electronics Engineers' (IEEE) 802.11 standards (e.g., 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAx, and WiMAx-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPv6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Optionally” as used herein means discretionary; not required; possible, but not compulsory; left to personal choice.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Personal computing device” generally refers to a computing device configured for use by individual people. Examples include mobile devices such as Personal Digital Assistants (PDAs), tablet computers, wearable computers installed in items worn on the human body such as in eyeglasses, watches, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.

“Portion” means a part of a whole, either separated from or integrated with it.

“Predominately” as used herein is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the x8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the Fx, Phenom, Athlon, Sempron, or Opteron processors manufactured by Advanced Micro Devices of Sunnyvale, California, USA; or the Snapdragon SoC processors manufactured by Qualcomm of San Diego, California, USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g., “true” or “false”). Processing activities may occur in multiple single processors on separate servers, on multiple processors in a single server with separate processors, or on multiple processors physically remote from one another in separate computing devices.

“Retain” generally refers to the act of keeping possession or use of something; the act of remembering by keeping in mind or memory, such as in the context of storing in a computer memory whether in volatile, nonvolatile, or other memory; or to hold one object secure or intact relative to another such as in the physical sense via a fastening member or material.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

```
if(clouds.areGrey( ) and
(clouds.numberOfClouds > 100)) then {
  prepare for rain;
} else {
  Prepare for sunshine;
}
```

“Sense Parameter” generally refers to a property of the environment detectable by a sensor. As used herein, a sense parameter can be synonymous with an operating condition, environmental factor, sensor parameter, or environmental condition. Sense parameters may include temperature, air pressure, speed, acceleration, the presence or intensity of sound or light or other electromagnetic phenomenon, the strength and/or orientation of a magnetic or electrical field, and the like.

“Sensor” generally refers to an object whose purpose is to detect a sense parameter such as events and/or changes in the environment, and then provide a corresponding output. Sensors include transducers that provide various types of output, such as electrical and/or optical signals. By way of non-limiting examples, the sensors can include cameras, pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Signal” generally refers to a function or means of representing information. It may be thought of as the output of a transformation or encoding process. The concept generally includes a change in the state of a medium or carrier that conveys the information. The medium can be any suitable medium such as air, water, electricity, magnetism, or electromagnetic energy such as in the case of radio waves, pulses of visible or invisible light, and the like.

As used herein, a “signal” implies a representation of meaningful information. Arbitrary or random changes in the state of a carrier medium are generally not considered “signals” and may be considered “noise”. For example, arbitrary binary data streams are not considered as signals. On the other hand, analog and digital signals that are representations of analog physical quantities are examples of signals. A signal is commonly not useful without some way to transmit or send the information, and a receiver responsive to the transmitter for receiving the information.

In a communication system, for example, a transmitter encodes a message to a signal, which is carried to a receiver by the communications channel. For example, the words “The time is 12 o'clock” might be the message spoken into a telephone. The telephone transmitter may then convert the sounds into an electrical voltage signal. The signal is transmitted to the receiving telephone by wires, at the receiver it is reconverted into sounds.

Signals may be thought of as “discrete” or “continuous.” Discrete-time signals are often referred to as time series in other fields. Continuous-time signals are often referred to as continuous signals even when the signal functions are not continuous, such as in a square-wave signal.

Another categorization is signals which are “discrete-valued” and “continuous-valued”. Particularly in digital signal processing a digital signal is sometimes defined as a sequence of discrete values, that may or may not be derived from an underlying continuous-valued physical process. In other contexts, digital signals are defined as the continuous-time waveform signals in a digital system, representing a bit-stream. In the first case, a signal that is generated by means of a digital modulation method may be considered as converted to an analog signal, while it may be considered as a digital signal in the second case.

“Switching device” generally refers to a device that is capable of dynamically allowing or interrupting current flow. Examples of such devices include, but are not limited to, mechanical switches, relays or contactors, a Triode for Alternating Current (TRIAC) or other bidirectional triode thyristor, or any type of transistor such as a Bipolar Junction Transistor (BJT) including NPN or PNP transistors, or a Field Effect Transistor (FET) such as a Junction FET (JFET), or Metal Oxide Semiconductor FET (MOSFET) to name a few non-limiting examples.

Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.

“Vehicle” generally refers to a self-propelled or towed device for transportation, including without limitation, car, truck, bus, boat, tank or other military vehicle, airplane, helicopter, drone, truck trailer, truck cab, boat trailer, other trailer, emergency vehicle, and motorcycle.

“Venue” generally refers to a facility hosting or presenting events or activities or where events may take place, for example, on a predetermined schedule, on a recurring basis such as daily, hourly, or weekly, or on an ad hoc basis whenever a sufficient number of participants are gathered. Example venues include race tracks, road courses, cross country courses, stadiums, Olympic parks, convention centers, theme parks, and the like. The events offered may include activities that may be participated in by individuals, or by groups of individuals together or in competition against other individuals or groups. The events may include, but are not limited to automobile races (such as truck, motorcycle, or car races), foot races, Olympic events, horse races, dog races, or other events that may or may not involve sports.

What is claimed is:

1. A method, comprising:
initializing wireless communication links between multiple position indicator assemblies of multiple vehicles and a management service, wherein the multiple vehicles are in a venue, wherein a timing system of the venue is operable to determine timing data associated with the multiple vehicles, wherein the management service receives the timing data from the timing system via a computer network, wherein the management service is remote from the multiple position indicator assemblies of the multiple vehicles, wherein the management service is executed using one or more processors of one or more computers, and wherein at least one of the one or more processors is outside the venue;
accepting the timing data from the timing system using the management service.
using the management service to process the timing data to determine vehicle positions relative to other vehicles;
comparing the vehicle positions against position indicator criteria using the management service to determine an updated position for one or more vehicles of the multiple vehicles operating in the venue;
sending the updated position to at least one of the multiple vehicles using the management service and the wireless communication links between the management service and the one or more vehicles; and
adjusting the position indicator assembly for the one or more vehicles to display the updated position.

2. The method of claim 1, comprising:
initializing additional wireless communication links between multiple other position indicator assemblies of multiple other individual vehicles and the management service, wherein the multiple other vehicles are operating in a second different venue, wherein a second timing system of the second venue is operable to determine relative positions of the other multiple vehicles, wherein the management service is responsive to timing input from the second timing system via the computer network, wherein the management service is remote from the other multiple position indicator.

3. The method of claim 1, wherein the position indicator includes one or more LEDs operable to display an indicator corresponding to the position received from the management service.

4. The method of claim 1, wherein the multiple position indicator assemblies include:
a position indicator that is arranged and configured to display the position of the vehicle relative to other vehicles; and
a control circuit, wherein the position indicator is responsive to control input from the control circuit defining the position displayed by the position indicator, and wherein the control circuit is responsive to the management service via at least one of the wireless communication links.

5. The method of claim 1, comprising:
accepting a caution indication from the timing service using the management service;
sending a caution message from the management service to the multiple position indicator assemblies, wherein control logic of the multiple position indicator assemblies is operable to receive the caution message and to activate a caution mode of the control logic; and
triggering a caution indicator of the position indicator assembly when the caution mode is activated.

6. The method of claim 5, wherein the caution indicator is displayed instead of the position when the caution mode is activated.

7. The method of claim 5, comprising:
accepting a clear caution indication from the timing service using the management service;
sending a clear caution message from the management service to the multiple position indicator assemblies, wherein the control logic is operable to deactivate the caution mode when the clear caution message is received.

8. The method of claim 7, wherein the position indicator is displayed instead of the caution indicator when the caution mode is deactivated.

9. The method of claim 1, wherein the updated position is sent to all of the multiple vehicles, and wherein control logic of the multiple position indicator assemblies is configured to match the update sent to the at least one of the multiple vehicles position update is meant for.

10. The method of claim 4, wherein the position indicator includes one or more multicolored LEDs.

11. The method of claim 10, wherein the multicolored LEDs are operable to emit red, green, or blue light, or any combination thereof.

12. The method of claim 4, wherein the position indicator is operable to emit light of differing colors corresponding to the position.

13. The method of claim 4, wherein the position indicator defines a recognizable pattern corresponding to the position received from the management service.

14. The method of claim 4, wherein the position indicator defines a numerical pattern corresponding to a numerical position received from the management service.

15. The method of claim 1, wherein the wherein the management service is executed as a running process executed by the one or more processors of the one or more computers, and wherein at least one of the one or more processors is located inside the venue.

16. The method of claim 1, wherein the multiple vehicles include multiple cars.

17. The method of claim 1, wherein the multiple position indicator assemblies include multiple position indicators mounted in different locations on the multiple vehicles.

18. The method of claim 1, wherein the venue is a racing venue having a predefined racecourse, and the multiple vehicles are any one of cars, motorcycles, trucks, aircraft, or watercraft.
